(19) United States
(12) Patent Application Publication
(10) Pub. No.: US 2010/0050197 A1
(43) Pub. Date: Feb. 25, 2010

(54) OPTICAL CARD

(75) Inventors: Michael Griffin, Tampa, FL (US); Christopher Paradies, Odessa, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Disctekk, LLC, Tampa, FL (US)

(21) Appl. No.: 12/510,178

(22) Filed: Jul. 27, 2009

Related U.S. Application Data
(60) Provisional application No. 61/083,700, filed on Jul. 25, 2008.

(51) Int. Cl. G11B 7/0033; G06K 19/00

(52) U.S. Cl. 720/745; 235/493; G9B/7.004

(57) ABSTRACT

An improved optical cards includes one or more of the following features, comparatively high density material disposed at or near the periphery of the optical card to increase the rotational moment of inertia of a card without increasing the thickness of the card, comparatively high density layers added to a side opposite of the optical read side of an optical card, scratch protection disposed on the optical read surface of the optical media but not covering the tracks containing optically encoded data, or comparatively high density scratch protection disposed on the optical read surface of the optical media but not covering the tracks containing optically encoded data, and combinations of these features.

### CROSS-RELATED APPLICATIONS

This application claims the benefit of U.S. Appl. No. 61/083,700, entitled “Optical Card,” which is a provisional application filed on Jul. 25, 2008.

### FIELD OF THE INVENTION

The field is optical cards, such as CD-ROM and DVD formatted optical cards.

### BACKGROUND OF THE INVENTION

Optical cards of various sizes and shapes are known that are formatted in CD-ROM and DVD standard specification formats. Shaped CD's have been known since the mid-1990's and even earlier.

It is known to include a magnetic stripe on optical media cards having a form factor of a hockey-rink shape or rectangular credit card shape. These optical cards may be used as credit cards, provided that the cards are thin enough to be swiped through a magnetic stripe card reader. However, as optical cards are reduced in thickness and size, the rate of playability of the cards is greatly reduced. In addition, the polycarbonate of the optical media is easily scratched by swiping a card through a magnetic card reader. Others have designed special card readers just for optical cards or have included a scratch resistant hard coat to reduce scratching.

Special optical readers greatly diminishes the acceptance of optical cards as replacements for gift cards, fidelity cards, credit cards, identification cards and the like, because these cards cannot be used in the very large number of magnetic card readers already ubiquitously installed at points of sale, government offices and the like. Thus, it is advantageous for optical cards with magnetic stripes to be read in standard magnetic card readers.

While a scratch resistant hard coat reduces scratching and increases the durability of optical cards used with magnetic stripe readers, the application of a hard coat is not easy. The application must be thin and uniformly thick across the optical card. Otherwise, the hard coat obscures or diffracts laser light that is used to read the optical media. This causes an unacceptably low playability rate.

In addition, the thickness of the card is a concern. Magnetic strip readers are used with gift cards, credit cards, debit cards and the like that have a maximum thickness of between about 0.80 millimeters and 0.9 millimeters. Optical cards up to 1.2 millimeters have been tested successfully in some of the more popular magnetic stripe readers. However, it is thought that a thickness of 1.0 millimeters is the maximum allowable thickness of an optical card used routinely in magnetic stripe readers, at least along the portion of the card swiped through the magnetic stripe readers. More preferably, an optical card would have a thickness no greater than 0.9 millimeters.

### SUMMARY OF THE INVENTION

Improved optical cards comprise one or more of the following features: comparatively high density material disposed at or near the periphery of the optical card to increase the rotational moment of inertia of a card without increasing the thickness of the card, comparatively high density layers added to a side opposite of the optical read side of an optical card, scratch protection disposed on the optical read surface of the optical media but not covering the tracks containing optically encoded data, or comparatively high density scratch protection disposed on the optical read surface of the optical media but not covering the tracks containing optically encoded data, and combinations of these.

In one example of an optical card for use in an optical disk drive and for use in a magnetic stripe reader, the optical card includes a laser readable optical data ring, such that optically encoded data on the optical data ring is readable by the optical disk drive; a non-circular substrate having a first face and a second face opposite of the first face, the non-circular substrate incorporating the optical data ring such that the optical data ring is readable on the first face of the non-circular substrate, and the non-circular substrate including a hole inside the optical data ring, such that the hole is encircled by the optical data ring, and a peripheral region outside of the optical data ring; a magnetic stripe deposited on the second face of the non-circular substrate; and a scratch protection means for protecting the optical data ring from being scratched during swiping of the optical card through the magnetic stripe reader. For example, a scratch protection means may be provided by an ink deposited on the first surface of the non-circular substrate, such as by stamping, printing or otherwise.

In one example of an optical ink card, an ink of the scratch protection means is deposited on the first surface of the non-circular substrate within the peripheral region of the non-circular substrate, between the hole of the non-circular substrate and the optical data ring, or a combination of these. For example, the ink may be of a material having a substantially greater density than the density of the material of the non-circular substrate, the optical data ring or a combination of these. In one example, weight is added to the peripheral region of the non-circular substrate such that the moment of inertia of the optical card is increased compared to an optical card of homogeneous density by the ink, by a layer of comparatively dense material, by a plurality of discrete masses or a combination of these. For example, the plurality of discrete masses may be arcuate in shape, and each of the plurality of arcuate discrete masses may be disposed in an arcuately-shaped portion of the non-circular substrate defined by the peripheral region of the non-circular substrate.

In one example, the optical data ring is snap fit into the non-circular substrate. In another example, the optical data ring is adhesively bonded into a recessed portion of the non-circular substrate. In yet another example the optical data ring is snap fit and adhesively bonded into a recessed portion of the non-circular substrate.

One advantage of the scratch protection is that swiping of an optical card having a magnetic stripe on a side opposite of the optical read surface causes no or fewer scratches on the portion of the optical read surface having optically encoded data for reading by a laser. Testing shows that use of any magnetic stripe reader causes some scratching of a normal polycarbonate optical read surface of an optical disk. In a test of one magnetic stripe reader, a single swipe caused scratching that prevented the card from being optical read. In another magnetic stripe reader, an unprotected card survived ten swipes without affecting playability.

When scratch protection was added by stamping the surface of an optical card with text along an outer circumference of the optical card and an inner surface of the optical card, surprisingly, a text height of only about 0.01 millimeters proved effective in protecting the data ring of the optical card. Using the same magnetic stripe reader that caused an unprotected optical card to fail with only 1 swipe, an optical card of the same type with scratch protection provided by text having a text height of only about 0.01 millimeters was able to be read without any affect. Deep scratches were visible on the optical read surface of the unprotected optical card, which prevented the card from presenting any information when inserted into a compact disk drive. The protected optical card, even after ten swipes in the same magnetic stripe reader, had some lighter scratches on the optical read surface that did not affect the content provided by the optical media recorded on the optical card.

In other tests, significantly fewer, fainter and/or shorter scratches are observed on the optical read surface of optical cards that include stamped ink scratch protection than for an optical card of the same type absent any scratch protection. This is a very surprising and unexpected result and provides a very low cost and effective way of providing scratch protection on the optical read surface of an optical disk.

Another advantage of using stamped ink text and graphics as scratch protection of the optical read surface of an optical disk is improved aesthetic appearance compared to an unprotected surface that displays a large number of deep scratches on its optical read surface after only a few swipes through a magnetic card reader. Yet another advantage is that applying stamped ink using a pad printing process, using pad printing equipment, such as pad transfer printers of Autotran, Inc., is much more cost effective at less than one cent per card than the 2 to 5 cents per card cost for applying a thin film of hardcoat. In addition, the yield of pad printing is nearly 100% compared to only a 95% yield (5% rejection rate) for applying hardcoat to the optical read side of optical cards. In another advantage, silk screen printing is used for providing scratch protection on the optical read side of an optical card. It is very surprising and unexpected that such a low cost, simple process as silk screen printing or pad printing is capable of providing scratch protection to an optical card. Still another advantage is that the rate of playability is increased while allowing for a reduced weight.

### BRIEF DESCRIPTION OF THE FIGURES

Examples are illustrated in the following drawings, which are not necessarily drawn to scale. The drawings are provided not to limit the claims but to provide examples for the detailed description.

FIG. 1 provides a top plan view of an optical read surface of an optical disk protected by scratch protection.

FIG. 2 provides a view of an example of an opposite surface of the optical disk illustrated in FIG. 1.

FIG. 3 illustrates a side cross section of an example of an optical disk as illustrated in FIGS. 1 and 2; however, the drawing illustrates several features in one example, having a comparatively high density layer on the surface opposite from the data ring, a cylindrical, peripheral weight, and a arcuate weight, for increasing moment of inertia in a thin optical card.

FIG. 4 illustrates a top plan view for an example of an optical card having a shape different than the shape illustrated in FIG. 1 for the purposes of illustrating that the patentable features of the present invention are not limited to any one shape of optical card.

FIGS. 5 and 6 illustrate a top plan view and side plan view, respectively, of an arcuate mass for embedding into an optical card during moulding of the optical card.

FIG. 7 illustrates a tope plan view of another example of an optical card having a separately molded annular data disk and a frame element coupled to the disk.

FIGS. 8 and 9 illustrate a side cross sectional view and a detail view of the example of FIG. 7, respectively.

FIG. 10 illustrates a cross sectional view of a weight either for inserting into a recess or for inserting into a mould for integration with an optical card during moulding.

### DETAILED DESCRIPTION

Examples of optical disks comprising patentable features of the present invention are described; however, the examples described and the drawings presented are merely examples of the present invention. The claims that eventually issue should be interpreted in light of the specification, but the claims should not be limited by the description and drawings of the examples presented. In one example, scratch protection is added to an optical read surface of an optical disk by application of a protective layer, pad printing of a layer, text, graphics and/or symbols, or transfer of a layer, text, graphics and/or symbols on the optical read surface of an optical disk, such that the optical ring is not obscured or covered in any way by the scratch protection. In tests, the scratch protection prevented some scratching, reduced the severity of some scratching and/or prevented the scratching from causing substantial damage to the optical data ring. Thus, a thin optical card may be used for storing both optically encoded data in the data ring of optical media cards and magnetically encoded data on a linear magnetic stripe on an opposite surface from the data ring of the optical media, without the use of a scratch resistant hardcoat. Both silk screen printing and pad printing are used to provide scratch protection to optical disks. Other printing methods may be used, such as ink jet printing and the like.

In one example, the scratch protection applied using pad printing provides printed text and/or graphics having a thickness in a range from 0.01 millimeters to 0.04 millimeters. Preferably, the thickness is sufficient to provide good scratch resistance while not increasing the overall thickness of the portion of the card being fed through the magnetic stripe reader beyond 1.2 millimeters, more preferably 1.0 millimeters, more preferably still 0.9 millimeters. In one example, the ink is comprised of materials that, upon drying, effectively protect the data tracks of the optical media from becoming unreadable after swiping, while also protecting the surface of the magnetic stripe head from being scratched or scored by the protective printing. A friction reducing substance, such as PTFE or other low-friction substances, may be incorporated into the ink, for example.

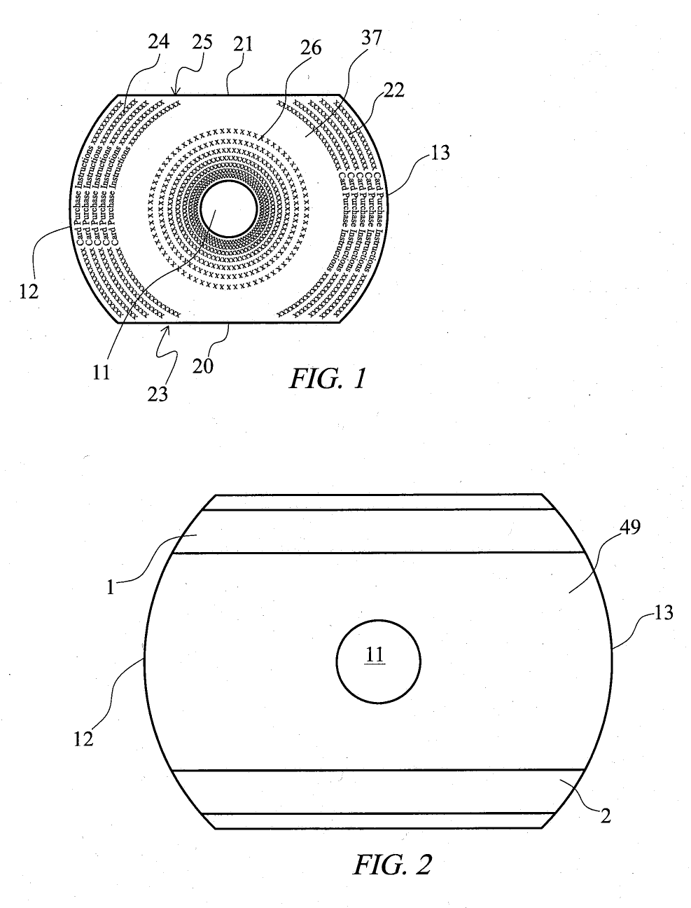

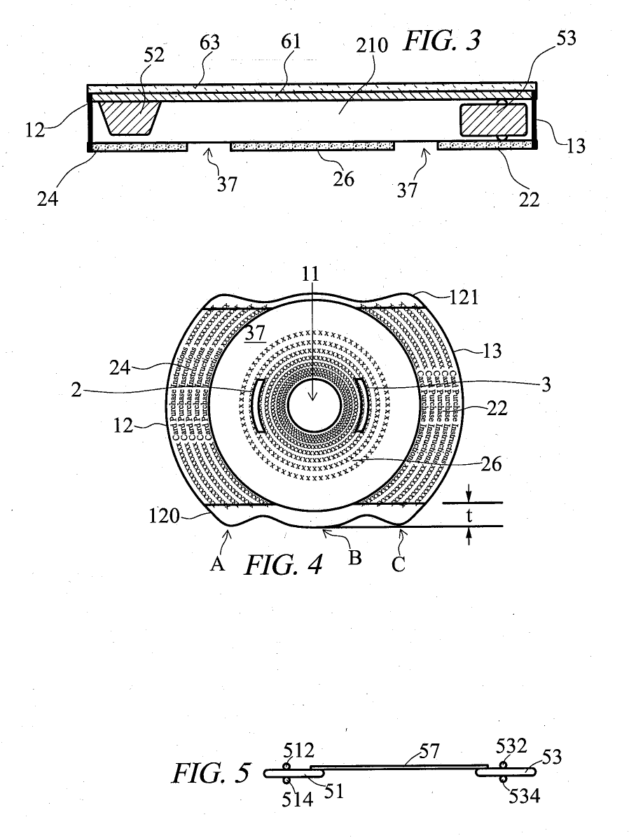

In order to increase playability rates of optical media cards that are thin enough to be used in the ubiquitous magnetic stripe readers already present at point of sale and government offices, examples are described of optical disks modified to increase the moment of inertia of the optical disks, while keeping the disks thin enough to be used in standard magnetic stripe readers. FIG. 3 illustrates four different mechanisms for increasing the moment of inertia of an optical disk, which may be used alone or in combination with one or more of the other mechanisms to achieve a desired moment of inertia. The features illustrated in FIG. 3 may be incorporated into the examples illustrated in either or both FIG. 1 and FIG. 4. The curvature of the edges of FIG. 4 is for aesthetics and is provided to show that many shapes may be adapted for use with the patentable features of the examples of the optical cards described.

Generally, without limiting the claims in any way, it is believed that some of the examples include mechanisms, each individually or in combination, that add an operatively sufficient rotational moment of inertia, by including a material of comparatively high density as a portion of the optical card. By increasing the rotational moment of inertia, it is believed, without be limiting in any way, that the thin optical media has an improved playability rate compared to an optical card of the same weight but having less rotational moment of inertia.

Specifically, the inventors believe, without limiting the claims in any way, that it is rotational moment of inertia and not merely weight that is the key to high playability rates for thin optical disks. It is believed that all applicable standards refer only to weight and/or size and/or density and not to moment of inertia. By positioning comparatively high density materials near or at the periphery of an optical disk, the rotational moment of inertia is increased more than if the optical card is merely increased by a uniformly dense layer over the entire surface of the optical card., thus allowing for greater playability without a corresponding increase in weight. Thus, less weight needs to be added to the periphery than would otherwise be required to achieve high playability rates by uniformly distributing weight over the surface of the optical card. In one example, both mass and scratch protection are provided by adding scratch protection that has a comparatively high density at or near the periphery of an optical card. To the extent that additional weight is needed to operatively increase the moment of inertia for standard drives, additional weight may be added using one or more of the other mechanisms illustrated in FIG. 3.

Now referring to the example illustrated in FIG. 1 and FIG. 2, an optical card has a magnetic stripe on a surface opposite from the optical read surface of the optical card. Generally, an optical card has a hole 11, a data ring 37 and edges 12, 13, 23, 25 defining a certain shape, such as the shape illustrated in FIG. 1, for example. The shape of the optical card may be any shape. A hockey-rink shaped optical card is illustrated in FIG. 1, while an optical card having no straight edges is illustrated in the drawing of FIG. 4. Other shapes, such as irregular, square, rectangular and the like, may also benefit from the improvements described herein.

For example, a magnetic stripe 1,2 may be located on the back side of an optical card along one or more edges 23, 25, such as illustrated in FIG. 2 for a hockey rink shaped optical card. According to industry standards, a two-track magnetic tape (stripe) meets the standard if it extends from 5.54 millimeters from a card edge to 11.89 millimeters from the same card edge. A three-track magnetic strip must extend to 15.95 millimeters from the card edge. Thus, the head on most magnetic tape readers extends from near the card edge to at least 16 millimeters. Since the optical region referred to herein as the data ring 37 extends as an annulus from at or near to the card edge, swiping of the card may cause either a wall of the magnetic stripe reader opposite of the read head, or the read head itself (i.e., in the case of a card reader having two opposing read heads) to pass over a portion of the optical region, thereby pressing it into contact with the wall or the read head, and if no scratch protection is present, causing scratching of unprotected data rings 37, which may cause an optical card to be unreadable.

Similarly, magnetic stripes may be disposed on the back side 49 of the example illustrated in FIG. 4 or any other shaped optical card having a side capable of having a magnetic stripe starting at about 5.54 millimeters from a bottom most edge. In the Example of FIG. 4, it is sufficient to have two bottom most points A,C or A,B or B,C along the edge to define a line parallel to a magnetic stripe. When two points are in contact with the magnetic stripe reader, then the card may be swiped through the reader such that the magnetic stripe passes through the reader linearly. In the example of FIG. 4, one of the sides has three points A, B, C linearly aligned along one edge, without any of the arcuate edges being linear. Thus, this example shows that any shape of optical card may be used, provided the side is capable of having a linear magnetic stripe aligned with any two points along one of the optical cards edges.

A length t is shown from the bottom-most points B, C to the end of a substantially uniform layer of scratch protection 120 in FIG. 4. This length t may be any length. Preferably, the length t is at least 1 millimeter and no greater than 7 millimeters, more preferably, no greater than 5 millimeters from the furthest most points A,B,C from an edge of the card. However, the scratch protective layer 120 may extend all the way around the optical data region 37 of the optical card, including the arcuate portions 22,24 and the opposite edge portion 121 of the optical card. Functionally, the length t should be selected such that the scratch protective layer 120, which may have a thickness in a range from at least 0.01 millimeters, does not interfere with swiping of the card past the head of the magnetic stripe reader. This depends on the thickness of the optical card, the thickness added to the optical card by the magnetic stripe and any protective layer, the thickness of the scratch protective layer, and the design of the magnetic card reader, which conforms to certain standards known in the art. Thus, based on the examples and disclosure provided, an optimization may be made for a specific shape and thickness of optical card.

It is preferred that a portion of the head of a magnetic stripe reader, or the wall of the magnetic stripe reader opposite of the read head, come into contact with the scratch protection 120, 121, 20, 21, 22, 24, 26, as illustrated in FIGS. 2 and 4, rather than making direct contact with the optical data ring 37. Thus, it is preferable that the thickness of the scratch protection layer, symbols, text and/or graphics and the distance between portions of the scratch protection be selected such that the wall opposite of the read heads or the read heads of magnetic stripe readers, which are not flat but have a curvature to guide cards past the head, bridge from one scratch protection surface to the next and do not make any, or at least less, contact with the surface of the data ring 37.

In one example, scratch protection having a thickness of about 0.01 millimeters was sufficient to protect the data ring 37 of an optical card shaped and protected as shown in FIG. 1 from substantial damage to the data ring 37. Herein, substantial damage is defined as damage that prevents an optical card reader from reading the data stored in the data ring 37 of the optical card.

In one test of an optical card according to the example shown in FIG. 1, an optical card having about 0.01 millimeter thickness of scratch protection 20, 21, 22, 24, 26 had no substantial damage after ten swipes through a magnetic stripe reader, while an unprotected card had substantial damage that prevented the card from being read in an optical card reader after only 1 swipe through the same magnetic stripe reader. This is a very surprising and unexpected result, providing an optical card that is protected against substantial damage from scratching while keeping the price of the optical card competitive with other technologies, such as bar codes.

In FIG. 3, a cross sectional view of an optical card includes a polycarbonate card 210 having an optical data ring 37 protected from scratching by scratch protection 22, 24, 26 disposed on the optical read surface of the polycarbonate card 210. The scratch protection 22, 24 at the periphery of the polycarbonate card 210 comprises a comparatively high density material, such as copper, stainless steel, a tungsten compound or alloy, nickel, silver or some other material having a density greater than 4 grams per cubic centimeter or alloys of these.

The density of polycarbonate is reported as 1.2 grams per cubic centimeter. The density of elemental metals, such as copper, iron and nickel are in the range of 7-9 grams per cubic centimeter. Some other materials have even greater densities than these. As one example, elemental nickel has a density of 8.8 grams per cubic centimeter. Thus, a 60% loading of nickel at 8.8 grams per cubic centimeter in a binder/colorant ink having a density of about 1 gram per cubic centimeter, provides a composite density of 0.00568 grams per cubic millimeter, which provides a mass of 0.357 grams if the area of two arcuate regions 22, 44 are covered in a layer of the composite material. An 80% loading of nickel in the same binder/colorant ink provides a composite density of 0.00724 grams per cubic millimeter, and a mass of 0.455 grams.

Testing of cards in multiple drives of differing types shows that a hockey rink shaped CD, having the shape shown in FIG. 1, an outside diameter of 80 millimeters, a thickness of 1.2 millimeters, and a width of 58 millimeters works in every drive tested. However, the 1.2 millimeter thickness is too thick for some magnetic stripe readers and is likely to void the warranty and cause premature even in those readers capable of handling such a thick card. However, this is a useful reference for mass and moment of inertia calculations. Such a card has a measured mass of 5.98 grams of which 5.84 grams are estimated to be of polycarbonate at a density of 1.2 grams per cubic centimeter and 0.135 grams are attributable to the magnetic tape, printing and surface features standard to every card. Testing shows that a card having a mass of 5.5 grams and the same form factor did not always work in drives tested. Therefore, a moment of inertia equivalent to a card having a mass of 6.0 grams is a reasonable choice for establishing a new standard for cards having this form factor. The moment of inertia of a 6 gram card having this shape is about 39 gram cm².

Manufacturer's standards for magnetic stripe readers call for cards with a thickness of about 0.86 millimeters; however, testing shows that all card readers are able to be used with cards having a thickness of 0.90 millimeters without any apparent deleterious wear or damage to the heads or other components in the readers. A hockey rink shaped card having a thickness of 0.9 mm, a distance between arcuate ends of 80 millimeters and a width of 58 millimeters has a mass of 4.32 grams. The moment of inertia is about 28 gram cm²; therefore, the additional moment of inertia needed is about 11 grams cm².

In one example, the ink used near and/or at the periphery of the optical card comprises a 0.02 millimeter to 0.04 millimeter thickness of scratch protection 22,24. The scratch protection 22, 24 may be applied at the periphery of the cards in an arcuate layer having an arc diameter the same as the arcuate edges of an 80 millimeter wide optical card and an inner circumference of the inner edge of the arcuate layer extending to the data ring, a radius of 29 millimeters, for example. For example, the maximum combined area of the two arcuate layers on opposite sides of the data ring is about 1570 square millimeters. At a thickness of 0.04 millimeters, the volume is 62.8 cubic millimeters. An inner ring of scratch protection 26 may have the same or a different thickness and composition as the outer arcuate regions 22, 24 and the contribution to the moment of inertia is small but not negligible. An estimate of the moment of inertia added by scratch protection having about 70% nickel in a composite of nickel, binder and colorant added to the surface on the optical card is about 5 gram cm². For a card having a thickness of 0.86 millimeters prior to adding a 0.04 millimeter thickness, the addition of a thick scratch protection layer 22, 24, 26 provides a substantial increase in the moment of inertia. Addition of 5 grams cm² in the moment of inertia of the optical disk is likely to improve playability on many, but not all, optical drives.

To further increase playability, a layer of comparatively high density material 61, such as nickel or other high density metals, may be added to the surface opposite of the optical read surface. In this example, a layer 61 having a thickness of only 0.3 millimeters of nickel may be added to the back surface of a polycarbonate optical card 210 having a thickness of 0.83 millimeters and a 70% nickel composite scratch protection layer 22, 24, 26 in order to provide a card having substantially the same moment of inertia as a 1.2 mm thick polycarbonate card. Thus, a total thickness of 0.9 mm (including the thicknesses of the 0.83 millimeter polycarbonate 210, the 0.04 millimeter scratch protection layers 22, 24, 26 and the 0.03 millimeter nickel layer) achieves substantially the same moment of inertia as a 1.2 mm thick monolithic polycarbonate card.

In another example, a thinner scratch protection layer 22, 24, 26 or scratch protection 22, 24, 26 other than in a uniform layer, such as text, graphics and symbols, instead, or a combination of both, may be desired. Two alternatives are illustrated in FIG. 3. Both alternatives insert a material 52, 53 having a density much greater than polycarbonate within the thickness of the polycarbonate card 210. By disposing the mass near or at the periphery of the optical card, only a small mass is required to achieve a moment of inertia at or greater than the moment of inertia of a 1.2 millimeter, monolithic polycarbonate optical card.

For example, ten masses of one grain in the form of cylindrical slug, truncated cone, or the like may be disposed at a radius from the center of the card of 35 millimeters. This is sufficient to generate a moment of inertia in a 0.86 millimeter thick optical card that is substantially the same as a monolithic polycarbonate card having a thickness of 1.2 millimeters, given the same dimensions as used previously for an optical card shaped as illustrated in FIG. 1. For example, each mass 52 may be centered at a radius of 35 mm and may be evenly spaced along the circular arc of radius 35 mm. Fewer masses are required to achieve substantially the same or a greater moment of inertia than 39 gram cm² if a layer of material 61 having a high density is added to the surface opposite of the optical read surface, as illustrated in FIG. 3. Also, an additional layer 63 may be added to protect the layer of material 61 and/or to add an additional layer of high density material, such as by pad printing, stamping, screen printing, sputtering, or applying such a layer. The additional layer 63 may comprise graphical elements and text or the like as ornamental features for example.

The masses 52 may be inserted in moulded pockets formed in the polycarbonate card 210. In one method, the polycarbonate is moulded around masses 52 disposed on a thin plate 61 of a comparatively high density material, such as a copper, nickel, iron or other metals, their alloys and the like. In this example, the masses 52 may have ridges or may be inverted to cause the masses 52 to be secured in the polycarbonate card 210. Alternatively, the masses 52 may be inserted into pockets formed in the polycarbonate card 210, such as during moulding of the polycarbonate card 210. In this example, the masses 52 may be positioned in the pockets, separately or together with other masses and/or a comparatively high density layer 61, using pick and place equipment in an automated process. An adhesive may be used to bond the masses 52 to the polycarbonate card 210, or the process may be performed while the surface of the polycarbonate card 210 is soft and/or tacky, in order to press the masses 52 into intimate contact with the polycarbonate, or a combination of both may be used.

On the opposite side of the polycarbonate card 210 of FIG. 3, an arcuate mass 53 is disposed, as another example of a comparatively high density mass that may be used to increase the moment of inertia of the polycarbonate card 210. A similar mass for the arcuate mass 53 will have the same effect as the use of individual masses 52. However, an arcuate mass reduces the number of pieces to be placed and may provide for a thinner form factor more integrally formed within the polycarbonate. In one example, the arcuate mass 53 is embedded into the polycarbonate card 210 during moulding of the polycarbonate card. However, the same method could be used for arcuate masses 53 disposed on each periphery of the arcuate edges 12, 13 as was used for the plurality of individual masses 52 disclosed earlier.

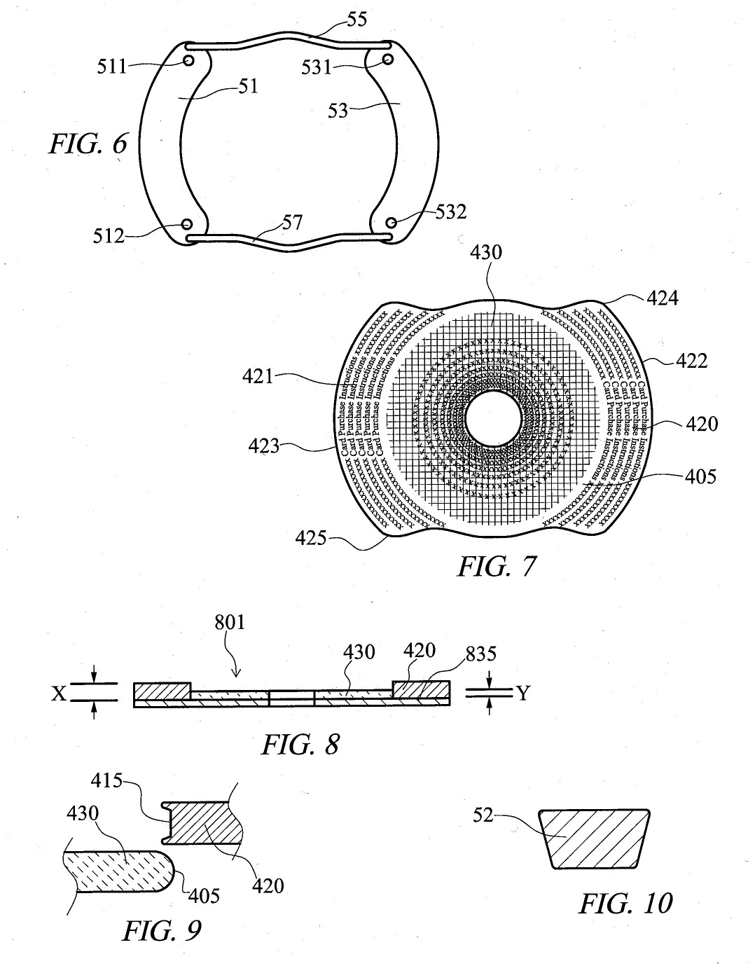

A side view of a pair of arcuate masses 51, 53 is illustrated in FIG. 5. In this example, spacers 512, 514, 532, 534 are provided for positioning the arcuate masses 51, 53 in a mould, and two positioning supports 55, 57 are coupled to the arcuate masses 51, 53, as illustrated in FIG. 5 and FIG. 6.

In addition to other features FIG. 4 illustrates the use of pad printing or the like for placing comparatively thick, partial stacking rings 2,3 on the optical read surface of a card. Stacking rings are well known in the art and are usually molded into the surface of a card to provide for easy separation of a stack of cards. However, the stacking rings, if sufficiently thick might cause the card to be too thick for swiping through a magnetic stripe reader; therefore, partial rings 2, 3 are provided that do not extend into magnetic stripe readers, when a card is swiped through the reader. FIG. 4 also illustrates a wide edge layer 120 contrasted with a narrower edge layer 121. In one example, the optical card has only one magnetic stripe (not two as shown in FIG. 2. Thus, only one edge of the optical card may require a wide edge layer 120. However, it may be desired to have symmetric features in order to reduce scratching of the optical data ring 37 when inserted the wrong way in a magnetic stripe reader or for better balancing of the optical card in a disk drive.

In the example illustrated in FIG. 7, an optical card may be comprised of an annular optical disk 430 of a polycarbonate polymer commonly used in producing optical disks, such as CD-ROM disks. The disk 430 may be inserted into a higher density frame element 420, such as a glass, mineral or metal filled polymer or combinations of these, for example. Any suitable material may be used for the high density frame 420, such as a polycarbonate, a polyester, a nylon, a phenolic or a copolymer. As in the earlier examples, the frame 420 may be stamped or printed with scratch protection 421 or the frame 420 may be of a slightly larger thickness X than the thickness Y of the disk 430, which may provide scratch protection for the disk 430 during swiping of the card through a card reader, as illustrated in the example of FIG. 8. In FIG. 8 a binding layer 835 is adhered to a surface of the optical card opposite of the optical reading surface 801.

In one example, the disk 430 of FIGS. 7-9 has a diameter of 58 millimeters to its outermost edge 405, where the outermost edge 405 of the disk 430 fits into the innermost edge 415 of the frame element 420, such as illustrated in the example of a detailed view of a cross section in FIG. 9. One of the edges may be convex while the other may be concave, for example, allowing a tight snap fit between the two components of the optical card. The left edge 423 of the frame element 420 and the right edge 422 of the frame element 420 may be of a circular diameter of about 80 millimeters, for example, such that the optical card 430 fits in the 80 millimeter ring of a CD-ROM drive. Other dimensions and materials may be used for the optical disk, which may be snapped or press fit into the frame element 420. A binding layer 835, as illustrated in the cross sectional view of FIG. 8, may be applied to one or both sides of the card, such that the binding layer adheres to both the frame element 420 and the disk 430. In another example, the disk 430 is ultrasonically welded to the frame element 420, which provides a high quality bond between the disk 430 and the frame element 420, even if dissimilar materials are used for each of them.

Now referring to the moment of inertia advantage of using a comparatively high density material as a frame element 420, the arcuate ends of the frame element, alone, provide an area of 1571 square millimeters. A density of metal, glass and/or mineral filled polymer may be in a range from 1.4 to 2.1 grams per centimeter cubed (g/cc) for a wide variety of polymers, both thermopolymers and thermosets. For example, a poly(ethylene terephalate) with a sixty percent fill of long glass fiber or chopped glass fiber and/or other high density fill has a density of at least 1.9 g/cc. At a thickness of 0.86 millimeters, the volume of the frame element 420 is about 1350 cubic millimeters. Thus, the increase in the moment of inertia compared to ordinary polycarbonate is 11.6 gram square centimeter, an amount sufficient to improve the playability rates of optical cards. If even 5% of the volume of the frame element 420 is nickel powder, the density of the glass filled poly(ethylene terephalate) becomes greater than 2.2 g/cc. Instead of 11.6 grams cm² the increase in moment of inertia is now greater than 17 grams cm²; therefore, using a high density filler such as nickel, even at only 5% by volume, results in a dramatic increase in the moment of inertia compared to using glass fiber loading of the polymer only.

FIG. 10 illustrates one example of a mass 52 used for increasing the moment of inertia of an optical card. The mass 52 may be inserted into a recess formed in an optical card or may be integrated into the moulding of an optical card. In one example, the mass 52 is disposed into a recess and then a surface layer is applied over the mass 52.

Alternative combinations and variations of the examples provided will become apparent based on this disclosure. It is not possible to provide specific examples for all of the many possible combinations and variations of the embodiments described, but such combinations and variations may be claims that eventually issue.

What is claimed is:

1. An optical card for use in an optical disk drive and for use in a magnetic stripe reader, comprising:
a laser readable optical data ring, such that optically encoded data on the optical data ring is readable by the optical disk drive;
a non-circular substrate having a first face and a second face opposite of the first face, the non-circular substrate incorporating the optical data ring such that the optical data ring is readable on the first face of the non-circular substrate, and the non-circular substrate including a hole inside the optical data ring, such that the hole is encircled by the optical data ring, and a peripheral region outside of the optical data ring;
a magnetic stripe deposited on the second face of the non-circular substrate; and
a scratch protection means for protecting the optical data ring from being scratched during swiping of the optical card through the magnetic stripe reader.

2. The optical card of claim 1, wherein the scratch protection means is provided by an ink deposited on the first surface of the non-circular substrate.

3. The optical card of claim 2, wherein the ink is deposited on the first surface of the non-circular substrate within the peripheral region of the non-circular substrate.

4. The optical card of claim 3, wherein the ink is deposited on the first surface of the non-circular substrate between the hole of the non-circular substrate and the optical data ring.

5. The optical card of claim 2, wherein the ink is deposited on the first surface of the non-circular substrate between the hole of the non-circular substrate and the optical data ring.

6. The optical card of claim 1, wherein weight is added to the peripheral region of the non-circular substrate such that the moment of inertia of the optical card is increased compared to an optical card of homogeneous density.

7. The optical card of claim 6, wherein the weight includes a plurality of discrete masses incorporated into the peripheral region of the non-circular substrate.

8. The optical card of claim 7, wherein the plurality of discrete masses are arcuate in shape, and each of the plurality of discrete masses are disposed in an arcuately-shaped portion of the non-circular substrate defined by the peripheral region of the non-circular substrate.

9. The optical card of claim 1, wherein the optical data ring is snap fit into the non-circular substrate.

10. The optical card of claim 1, wherein the optical data ring is adhesively bonded into a recessed portion of the non-circular substrate.

11. The optical card of claim 10, wherein weight is added to the peripheral region of the non-circular substrate such that the moment of inertia of the optical card is increased compared to an optical card of homogeneous density.

12. The optical card of claim 11, wherein the weight includes a plurality of discrete masses incorporated into the peripheral region of the non-circular substrate.

13. The optical card of claim 12, wherein the plurality of discrete masses are arcuate in shape, and each of the plurality of discrete masses are disposed in an arcuately-shaped portion of the non-circular substrate defined by the peripheral region of the non-circular substrate.
